(19) United States
(12) Patent Application Publication
(10) Pub. No.: US 2009/0182786 A1
(43) Pub. Date: Jul. 16, 2009

(54) APPLICATION COHERENCY MANAGER

(75) Inventors: Douglas Haanpaa, Dexter, MI (US); Glenn J. Beach, Grass Lake, MI (US); Charles J. Jacobus, Ann Arbor, MI (US); Devvan Stokes, Albany, NY (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/263,706

(22) Filed: Nov. 3, 2008

Related U.S. Application Data
(60) Provisional application No. 60/984,569, filed on Nov. 1, 2007.

(51) Int. Cl. G06F 12/00; G06F 3/048; G06F 12/16

(52) U.S. Cl. 707/203; 707/201; 715/764; 707/10; 707/204; 707/3; 707/E17.014; 707/E17.044; 707/E17.01; 707/E17.032

(57) ABSTRACT

An application coherency manager (ACM) implements and manages the interdependencies of simulation, data, and platform information to simplify the task of organizing and executing large simulations composed of numerous models and data files. One or more file systems or repositories stories raw data in the form of files, data, or models, and a graphical users interface (GUI) enabling a user to enter and receive results from a query involving the files, data, or models. One or more coherency checking modules (CCMs) are operative to determine the types and versions of, and compatibility between, the files, data, or models. A database stores processed information about the file systems or repositories and the results of previous queries, and a data aggregator and manager (DAM) that manages the flow of information between the file system or repository, the GUI, the CCMs, and the database. The invention is applicable to simulation and non-simulation type applications such as document control, source code control, image libraries, etc.

### REFERENCE TO RELATED APPLICATION

This application claims priority from U.S. Provisional Patent Application Ser. No. 60/984,569, filed Nov. 1, 2007, the entire content of which is incorporated herein by reference.

### FIELD OF THE INVENTION

This invention is directed towards efficiently using large, distributed sets of data and files for various applications, including simulation, document control, or image archival. More particularly, the invention resides a method for crawling over a collection of files, data, or models, to identify the nature, version, and interoperability of each module.

### BACKGROUND OF TE INVENTION

With the proliferation of electronic data, files, and models, it is becoming increasingly difficult to identify which pieces of data are linked based on topic, version, application, or other criteria. For example, managing a large simulation can require assembling a large number of simulation components obtained from multiple locations. It is a challenge to verify that the collected models will interoperate properly and provide the desired results. Furthermore, if there is a large number of models or data files, it is problematic to quickly and efficiently locate only those files that are relevant to the current application.

Much work has been performed on organizing and searching large collections of data, such as information on the internet. However, no organized system has been developed to identify and verify the applicability and relevance of the returned information (at least beyond general keyword searches) to the application at hand.

When operating in a collaborative manner with other users, developers, maintainers, etc., files, data, and models are constantly being modified and changed. When the library of information becomes large, it becomes difficult to maintain insight into what modules are interoperable based on version, type, or application nature.

While systems exist for tracking and maintaining version control on files and data systems, these systems typically require that the data be initially saved with the necessary information to retrieve it properly. For example, source code versioning systems tag the source code with information to make it retrievable as a set of code and to tie individual instances of files to a particular version.

A simulation of any human-designed system attempts to minimize cost and risk in the development of actual prototype hardware. As with the technology being prototyped, the tools for performing such simulation will evolve over time. As a simulation application evolves, the requirements on the data on which it operates may also change. Sometimes such an application will be backward compatible and will be able to operate on the old data. Sometimes it will not. The input to such a simulation will often, in fact, consist of multiple data sources. The simulation application may impose requirements on the data sources. Additionally, there may be dependencies on the host operating system and/or the computer hardware (e.g. memory, hard drive, and CPU). Similar issues can arise with non-simulation type applications.

Previous researchers have developed systems and techniques for the distribution of data, file version control, content management, memory coherency, and other areas related to the current invention. However, no system tackles the issue of efficiently retrieving data, files, or models from a large, unstructured set of distributed databases or file systems.

The work by Basani et al. in U.S. Pat. No. 6,718,361 discusses how to efficiently transfer data files within a large-scale distributed network, but does not discuss the concept of determining which files are relevant to a particular version of a particular application. Basani does discuss the concept of content management systems that monitor for changes in files to properly update knowledge of file systems, but again does not address the larger issue of determining type and version of files.

The work by Rumbaugh et al. in U.S. Pat. No. 5,005,119 describes a flowgraph system for allowing a user to have interactive control over input and output data flow in CAD systems. The system is basically a type of GUI that allows the operator some visibility into the internals of the input and output streams.

The work by Ruizandrade in U.S. Pat. No. 7,076,496 discusses a method for maintaining software product version tracking in a client/server environment. The system includes storing product version information in a database and allowing the correct version of a file to be located within a large collection of files. However, this system assumes that the version information is available when the file is originally stored or updated.

The work by Clark et al. in U.S. Pat. No. 7,349,913 discusses a storage platform for organizing, searching, and sharing data. The platform does include a database that helps maintain organization and synchronization of data and allows applications to effectively access this database. However, this system assumes that the platform is designed specifically to support the system. The work by Nelson in U.S. Pat. No. 7,158,962 discusses a system and method for automatically linking items with multiple attributes to multiple levels of folders within a content management system. The system monitors files to maintain links between files based on system defined attributes. When these attributes change, the system updates link information accordingly.

The work by Clarke et al. in U.S. Pat. No. 7,017,012 describes a storage coherency system and method for maintaining data coherency across a number of storage devices sharing such data. This patent deals with keeping distributed data in sync with multiple copies of the same data. It does not encompass managing file type compatibility, version compatibility, or other such information.

### SUMMARY OF THE INVENTION

This invention resides in an application coherency manager (ACM) that can implement and manage the interdependencies of simulation, data, and platform information to simplify the task of organizing and executing large simulations composed of numerous models and data files. The ACM can also enforce a simulation configuration profile submission that includes the specification of the interdependency requirements between files (for example, ensuring that the same version of files are used).

The ACM includes one or more file systems or repositories storing raw data in the form of files, data, or models, and a graphical users interface (GUI) enabling a user to enter and receive results from a query involving the files, data, or models. One or more coherency checking modules (CCMs) are operative to determine the types and versions of, and compatibility between, the files, data, or models. A database stores processed information about the file systems or repositories and the results of previous queries, and a data aggregator and manager (DAM) that manages the flow of information between the file system or repository, the GUI, the CCMs, and the database.

A general-purpose language serves as the basis for higher-level rules that are assembled using the GUI. The GUI allows the operator to easily and quickly search the distributed repositories to locate and assemble the appropriate simulation models, data files, or other information. The CCMs scan distributed file systems and databases to build a detailed knowledge of the files within the system. This information is stored in a database that can be quickly accessed by the data aggregator and manager to rapidly respond to requests for information. The invention is applicable to non-simulation type applications such as document control, source code control, image libraries, etc.

### BRIEF DESCRIPTION OF THE DRAWINGS

FIG. 1 depicts the Application Coherency Manager architecture;

FIG. 2 shows an example of the main GUI window; and

FIG. 3 provides an example of the results window from the initial search.

### DETAILED DESCRIPTION OF THE INVENTION

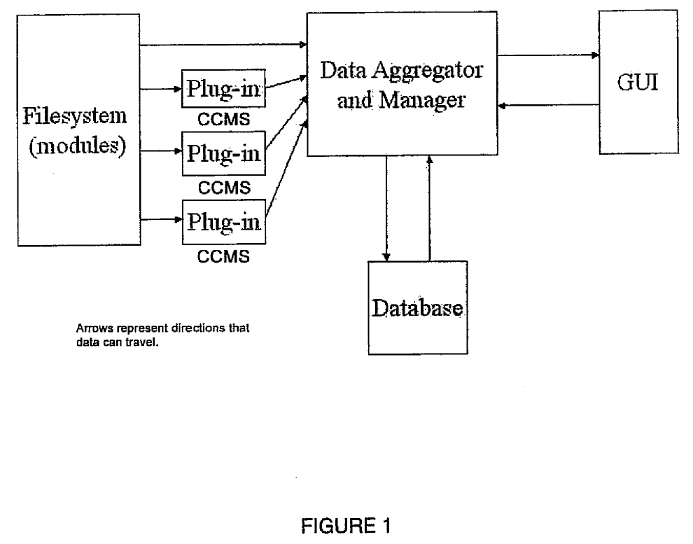

The invention described herein, the Application Coherency Manager or ACM. FIG. 1 is a drawing that depicts a layout of the ACM architecture, which includes the following components:

A Data Aggregator and Manager (DAM) that manages the flow of information within the architecture.

Plug-in Coherency Checking Modules (CCMs) that are capable of determining the types of, and compatibility between, files, data, and models. The CCMs adhere to an interface standard that allows new CCMs to be written and installed to identify new file and data types.

An intelligent Graphical Users Interface (GUI) for improving the process of searching for and displaying results from a query.

A database for storing processed information about the repositories and the results of previous searches.

A file system (or file systems) or repository (repositories) where the raw data is stored.

The layout of FIG. 1 shows the main components of the system with arrows representing the direction of data flow. The approach uses a layer of applications that can determine information about files to discover the overall nature (including type, version, interoperability issues) of the files. These applications (known as coherency checking modules or CCMs) can be similar to that used in MIME type detection in the sense that it involves inspecting a target file's extension and performing byte pattern matching within the file itself. A unique property of the CCMs is that they can be written specifically to efficiently identify files. For example, a parser from a simulation could serve as a CCM capable of detecting a specific format of input file.

The system architecture is scalable and allows for multiple versions of any component to be running simultaneously. That is, many client GUI's can simultaneously access a single DAM. Multiple DAMs can be connected to efficiently handle a larger set of repositories. A single DAM can access multiple databases and file systems. The number of CCMs is limited only by the system memory and power. In a multi-DAM system, the load on any individual DAM can be balanced with standard load balancing techniques.

The ACM allows users to quickly locate relevant files, data, and models. However, the system is applicable to use with automated systems. The GUI is the main interface to the operator who is searching for files, data, models, etc. The GUI provides an intuitive method for quickly searching through potential matches and a method for controlling the search process.

The DAM is the main control portion of the architecture. It includes functionality for analyzing the contents of the file system (to determine the nature and categorization of files), submitting and retrieving data from the database, and executing requests from the GUI. It is also responsible for communicating with other repositories of data. Furthermore, the DAM is responsible for controlling the actions of the file system crawler (which leverages the CCMs) to efficiently traverse the file systems and databases being searched.

The database stores information related to the files and content that has been processed by the DAM. The database stores relevant information about each item (including location and version of the file), and greatly increases the speed of retrieving file information. The crawler portion of the DAM is constantly analyzing the contents of the file systems and databases under management to identify changes and additions and update the control database. The control database is optimized to allow efficient data retrieval for fast performance during queries for file information (for example, “show me all files that work with my TerraNavigator application version 3.1”).

The CCM plug-in modules are designed to determine whether a file is or is not of a certain type or version. That is, some plug-ins may be designed to simply rule out a file as being a certain type or version (for example, an ASCII file cannot be an executable file), while other plug-ins are specifically for determining whether a file is of a specific type.

The file system includes file storage locations such as on servers (potentially multiple, remote servers) or in databases. The DAM will parse these storage locations to build a map of what information is where. The DAM can be implemented as a web portal that can be connected to by multiple GUIs or clients. This allows the ACM to easily work in a distributed fashion to improve overall usefulness.

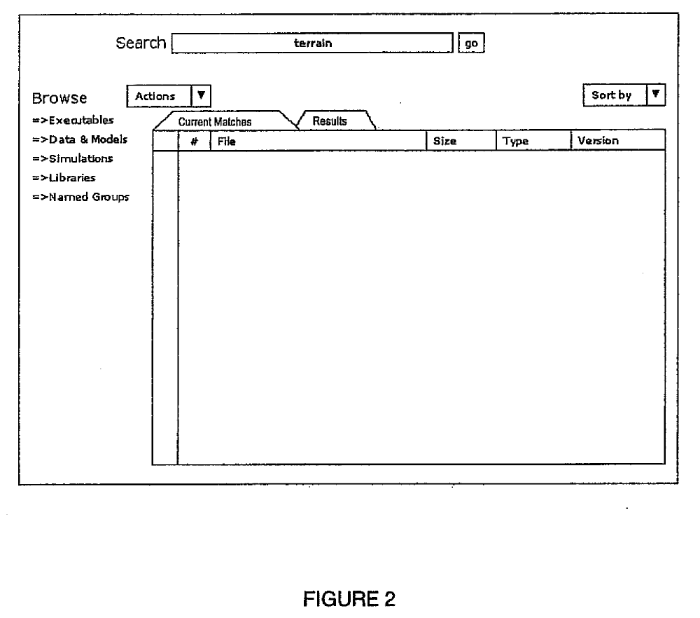

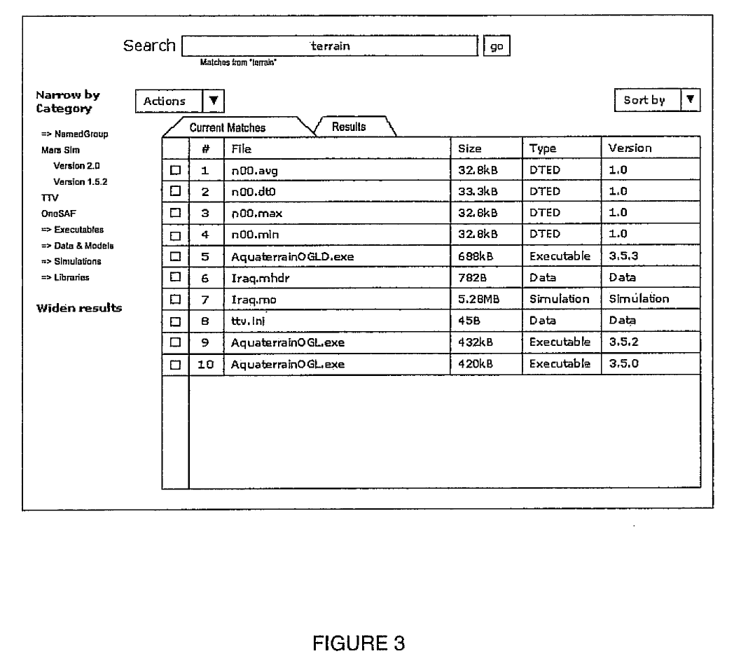

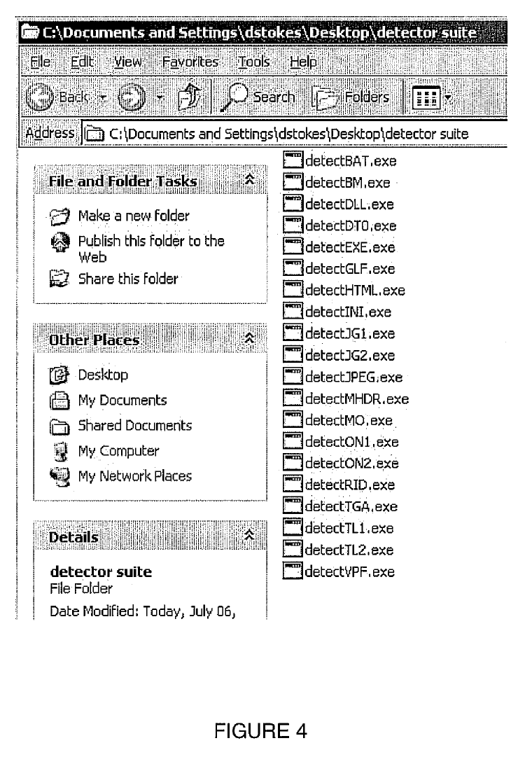

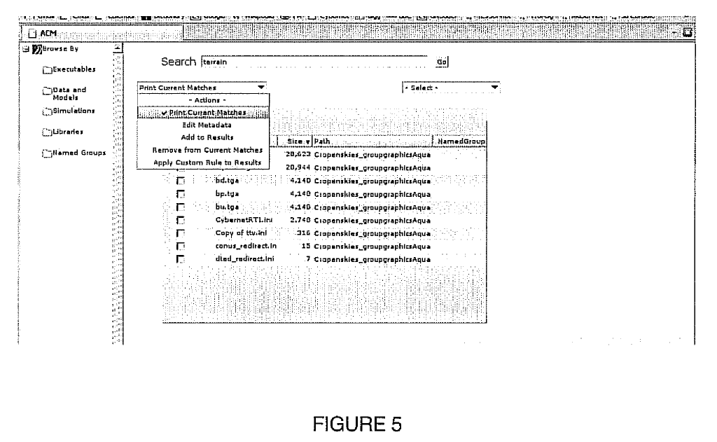

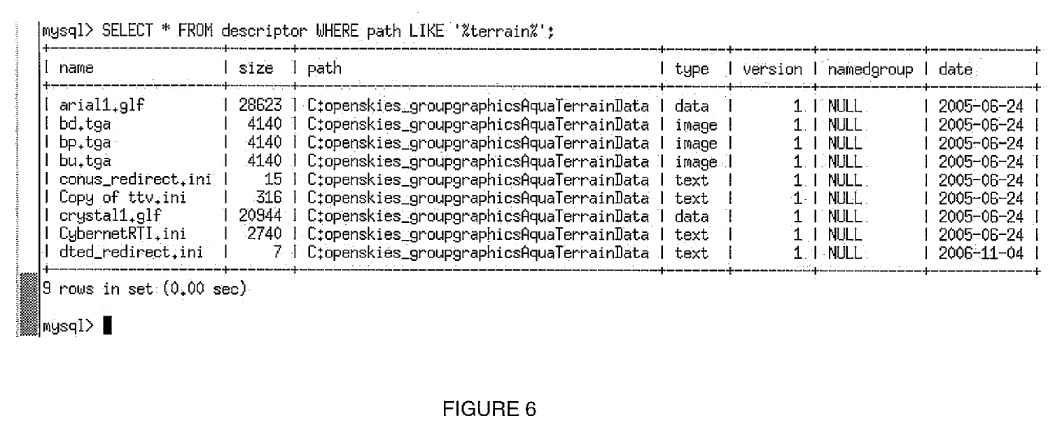

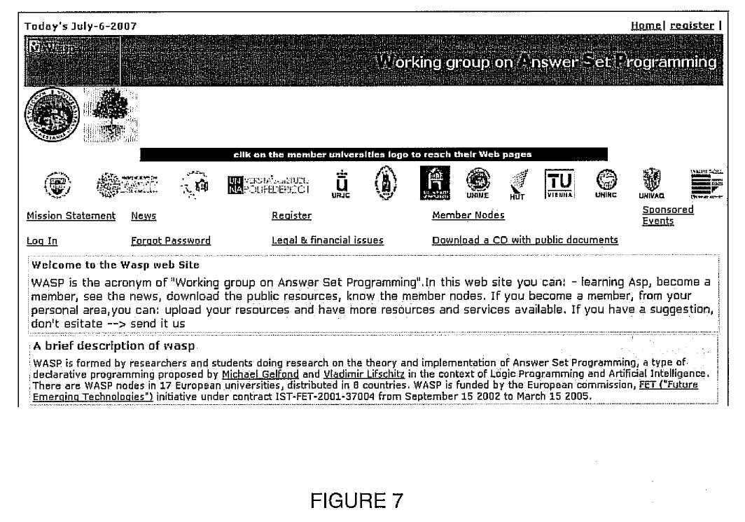

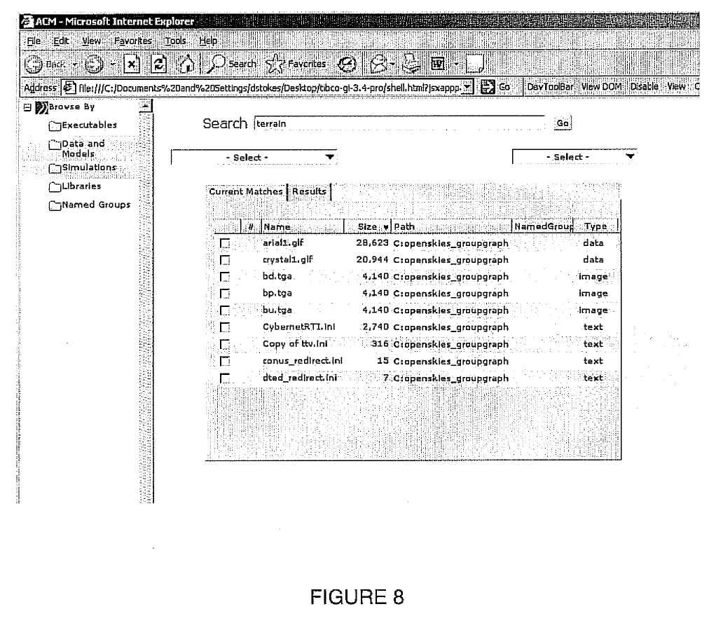

FIG. 2 contains a storyboard concept for the main GUI window for starting the ACM-based search for files or data. This screen provides the ability to enter keywords or metadata tags or to prune by types or characteristics by selecting a quick link. FIG. 2 and FIG. 3 provide examples of some GUI mockups. Basically, the GUI screens provide the ability to quickly view file, data, and model information from the DAM. The screens also allow the operator to guide the process, and to incorporate feedback (such as creating associations) in order to improve performance the next time data is requested. The various components of the ACM will now be described in further detail.

### The Coherency Checking Modules (CCMs)

To keep the format of these CCMs as generic as possible, each module is created as a stand-alone executable that can be invoked from within the DAM (which ones are invoked depends on the nature of the requested search). The CCMs are further integrated into a file system crawler, that provides type and version profiles for arbitrary directory structures. This crawler system can sweep over a group of modules to recognize whether they are of the type or version that they appear to be. Modules (which can be files, data, models, etc.) are then tagged with information marking them as coherent working groups. Due to the modular nature of the system, the number of applications responsible for determining the nature of the files can be easily increased as necessary.

### GUI Module

The GUI module presents information to the user and accepts queries from the user to define the search space or to prune results. The GUI code is capable of mapping data in well-formed XML documents to fields in the GUI widgets. XML schemas are written for mapping the outgoing search queries and for describing the query results to the GUI. In a current implementation, a JavaScript-based GUI is used to form queries, initiate searches, and display search results. This GUI can run as a stand-alone application or embedded in a browser. The GUI could also be developed with other languages such as standard Java, C++, PERL, or others.

One key element to the GUI concept is the ability for the GUI to reconfigure based on information returned from the current search. This allows the GUI to greatly support the user's effort to find relevant information.

### Servlet

A servlet module handles HTTP transactions between the GUI and the ACM server. This servlet (which can be deployed as a JBoss server), is responsible for all of the data transfer. It receives specific HTTP GETs and POSTs and responds with XML documents that contain information about the desired files, models, or documents. This Servlet is a key element in the Data Aggregator and Manager (DAM) discussed earlier. It also includes functionality for searching archives and file systems to find any required software modules.

### ASP Solver

Answer Set Programming (ASP) is used to develop the core engine for rapidly searching the database to find relevant files, models, or documents. The ASP solving engine includes a set of rules for solving our program data management (PDM) problem.

### Database

The database is responsible for storing knowledge about the locations and relationships between files and models in the repositories. The database is populated by a server-based program that continually monitors repositories (could be file systems, other databases, or other archives) to log information, and to make retrieval faster and more convenient. This database has been defined to include the necessary fields and records, but these entries are script-generated, instead of automatically generated.

The database is composed of both a metadata database and a module database. The metadata database contains a table of file descriptors. The descriptors are useful as a human-readable description of what modules are present, and also as raw input into the ASP solving engine. The engine is able to use a set of hand-written rules, along with the metadata, to answer questions as to whether a group of modules forms a working configuration. The module database contains information about how to recognize modules.

### Coherency Management

To perform actual configuration analysis of modules, the system employs an Answer Set Programming (ASP) engine. ASP is useful for answering queries about a group of tagged modules. Given specific restraints, an ASP engine can answer arbitrary queries about the relationships between the modules.

To achieve coherency, the system uses the CCMs in a tiered approach. On the lowest level, the design includes a suite of small, simple executables that answer very easy questions about an input file. Higher level CCMs use a number of simpler modules to answer more complex questions about collections of files. The structure is underpinned by rigorous predicate logic, which is evaluated by the ASP engine. ASP engines have been previously applied to solving similar program data management/configuration problems. At the lowest level, we ensure the integrity of files, and at the highest level, we will ensure interoperability between systems.

It is important that the ACM operators have a transparent view of the rules that determine the coherency of whatever software modules the system has access to. To ensure that this happens, the ASP rules will be wrapped in an XML schema, which itself will have a mapping to a graphical representation. It is this representation that the human operator can use to inspect the relationships and requirements between modules.

After a user has searched for files, subsets of the current matches can be selected and viewed in another window, where actions can be performed just on those results. It is here that the power of the ACM is expressed, in that arbitrary groupings of files can be inspected for coherency, tagged with metadata, downloaded and stored for future reference.

In summary, the ACM allows efficient file and data location on standard file and operating systems, including legacy data locations. The invention allows users to quickly and easily find all relevant files to a particular instance of an application within a distributed set of file systems. The ACM can determine type, version interoperability, and other information for legacy databases and file system that were not developed with a specific versioning control system in mind. Version information can be determined even when such information was not entered by a human operator (or an automated system) when the data was created. In addition to simulation-type applications, the ACM can be used to scour an electronic archive of old documents to determine what programs can open and edit them. Additionally, it could be used with a set of images to determine image format and potentially content. The GUI provides an operator with means to control and direct system operation, but it is not a flowgraph system, nor is it limited to CAD systems.

We claim:

1. An application coherency manager (ACM), comprising:
one or more file systems or repositories storing raw data in the form of files, data, or models;
a graphical users interface (GUI) enabling a user to enter and receive results from a query involving the files, data, or models;
one or more coherency checking modules (CCMs) operative to determine the types and versions of, and compatibility between, the files, data, or models;
a database for storing processed information about the file systems or repositories and the results of previous queries; and
a data aggregator and manager (DAM) that manages the flow of information between the file system or repository, the GUI, the CCMs, and the database.

2. The ACM of claim 1, including multiple, distributed file systems or repositories storing raw data in the form of files, data, or models.

3. The ACM of claim 1, including multiple DAMs that cooperate to handle a very large set of files.

4. The ACM of claim 1, wherein the DAM is operative to store information regarding user-defined relationships between files, data, or models.

5. The ACM of claim 1, wherein additional CCMs may be added to the ACM without recompiling or removing other system functionality.

6. The ACM of claim 1, wherein the DAM can automatically receive and process the output of additional new CCMs.

7. The ACM of claim 1, wherein the GUI is operative to dynamically configure itself to optimize feedback to a user.

8. The ACM of claim 1, wherein new CCMs may be added or modified to identify specific types or versions of files.

9. The ACM of claim 1, wherein the file systems or repositories contain simulation information.

10. The ACM of claim 1, wherein the file systems or repositories contain source code.

11. The ACM of claim 1, wherein the file systems or repositories contain documents.

12. The ACM of claim 1, wherein the file systems or repositories contain image libraries.

13. A method of managing information, comprising the steps of:
storing raw data in one or more file systems or repositories in the form of files, data, or models;
crawling over the raw data to identify the type, nature, version, or other coherency information about the files, data, or models; and
storing the coherency information in a database for more efficient, later retrieval by a user.
